(19) United States
(12) Patent Application Publication
(10) Pub. No.: US 2009/0265156 A1
(43) Pub. Date: Oct. 22, 2009

(54) DYNAMICALLY VARYING SIMULATION PRECISION

(75) Inventors: Martin Taillefer, Redmond, WA (US); Darek Mihocka, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/105,290

(22) Filed: Apr. 18, 2008

(51) Int. Cl. G06F 9/44

(52) U.S. Cl. 703/21

(57) ABSTRACT

Simulating a processor based system includes simulating first processor actions at a first precision level and detecting a first trigger. The simulation is dynamically changed to a second precision level that is different than the first precision level based on the first trigger. Second processor actions are simulated at the second precision level.

### BACKGROUND

Simulation of processor based systems is a valuable tool of hardware and software development. Processor based systems have become much more powerful over time with more processing power and more memory to handle advanced operations. As processor based systems get more and more complex, employing simulators is correspondingly more desirable in the hardware and software development process. Moreover, there are ever increasing varieties of processor based systems, such as server systems, personal computers, laptop computers, personal digital assistants (PDAs), mobile telephones, audio/video devices, other programmable consumer electronics, programmable automobile electronics, and many other consumer and industrial programmable systems.

One problem with simulation of processor based systems is that a simulation model of the processor based system running on a computer system typically runs significantly slower than the actual production version of the processor based system. This significant difference between simulation speed and actual system speed considerably lengthens the amount of time employed for a system simulation environment to execute the simulation model. This slow simulation is made even slower with today's more complex processor based system designs, where the time to simulate the complex systems is a more significant portion of the system design time. The extremely slow simulation performance is further exasperated when hardware or software developers attempt to simulate leading edge or future technologies while running the simulation on slower existing computer systems.

Accordingly, extremely slow simulation performance can substantially hamper hardware and software development, resulting in increased development time, increased cost of development, and/or possibly limiting the amount of relevant system validation performed by the simulation in a reduced time-to-market development environment.

A variety of simulation techniques have been employed to improve simulation efficiency. One such simulation technique, for example, is just-in-time compilation. These improved simulation efficiency techniques typically focus on speeding up the simulation process by reducing the overhead in replicating the functionality of the simulated processor based system.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one embodiment, a processor based system is simulated by dynamically varying simulation precision. First processor actions are simulated at a first precision level until a first trigger is detected. The simulation is dynamically changed to a second precision level that is more precise than the first precision level based on the first trigger. Second processor actions are simulated at the second precision level.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating a computer system according to one embodiment.

FIG. 2 is a block diagram of one embodiment of a simulator system application that could be implemented on the computer system illustrated in FIG. 1.

FIG. 3 is a flow diagram illustrating one embodiment of a method of simulating a processor based system by dynamically varying simulation precision.

FIG. 4 is a table illustrating example dynamically controlled simulation precision levels according to embodiments.

FIG. 5 is a table illustrating example triggers that influence dynamic change in simulation precision levels according to embodiments.

FIG. 6 is a flow diagram illustrating one embodiment of a method of simulating a processor based system by dynamically varying when accurate cache simulation is performed.

FIG. 7 is a flow diagram illustrating one embodiment of a method of simulating a processor based system by dynamically varying when precise reporting of exceptions is simulated.

FIG. 8 is a flow diagram illustrating one embodiment of a method of simulating a processor based system by dynamically varying when cycle-accurate simulation is performed based on interaction with at least one of debugger break points and debugger single-stepping.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

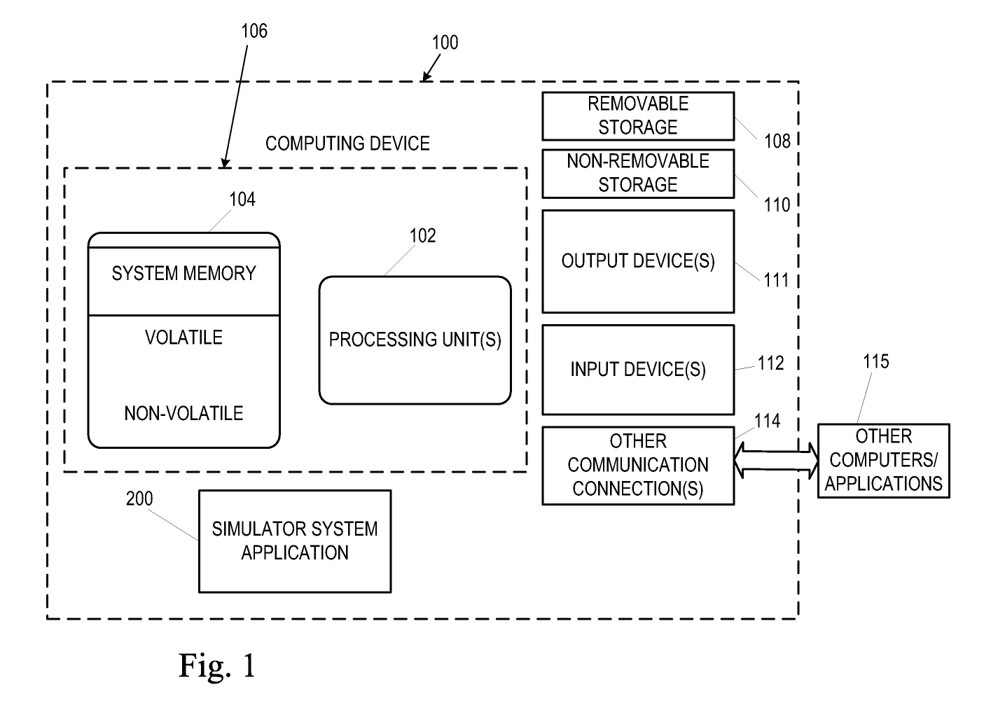

As illustrated in FIG. 1, an exemplary computer system that can be employed to implement one or more parts of an example simulator system includes a computing device, such as computing device 100. In a basic configuration, computing device 100 typically includes processing unit(s) (i.e., processor(s)) 102 and memory 104. Depending on the exact configuration and type of computing device, memory 104 may be volatile (such as random access memory (RAM)), non-volatile (such as read only memory (ROM), flash memory, etc.), or some combination of the two. This basic configuration is illustrated in FIG. 1 by dashed line 106.

Computing device 100 may also have additional features/functionality. For example, computing device 100 may also include additional storage (removable and/or non-removable) including, but not limited to, magnetic or optical disks, or tape, or flash storage devices. Such additional storage is illustrated in FIG. 1 by removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) flash drive, flash memory card, or other flash storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. Computing device 100 may also include input device(s) 112, such as keyboard, pointing device (e.g., mouse), pen, voice input device, touch input device, etc. Computing device 100 may also include output device(s) 111, such as a display, speakers, printer, etc.

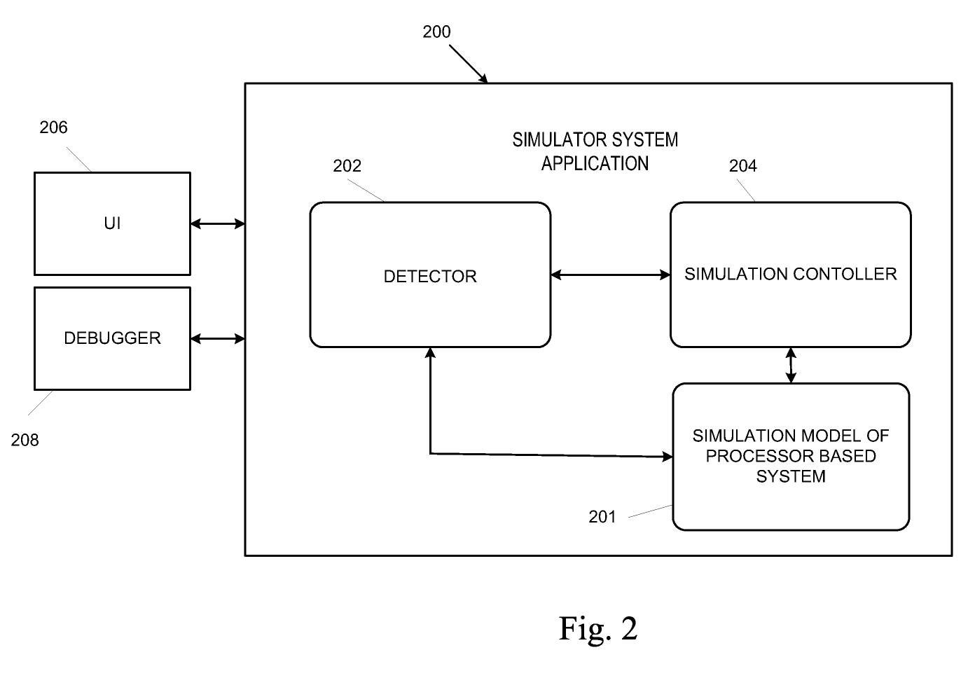

In one implementation, computing device 100 includes a simulator system application 200. Simulator system application 200 is described in further detail below with reference to FIG. 2.

One embodiment of a simulator system application 200 is illustrated in FIG. 2. Simulator system application 200 can be implemented on a suitable computer system, such as computing device 100 illustrated in FIG. 1. In one embodiment, simulator system application 200 is one of the application programs that reside on computing device 100. Simulator system application 200, however, can alternatively or additionally be embodied as computer executable instructions on one or more computers and/or in different variations than illustrated in FIG. 1. Alternatively or additionally, one or more parts of simulator system application 200 can be stored in system memory 104, on other computers/applications 115, or other such suitable variations for running a simulator system application.

Embodiments of simulator system application 200 are described herein in the general context of computer-executable instructions, such as program modules, being executed by a computer. Generally, program modules include routines, programs, objects, components, data structures, etc. that perform particular tasks or implement particular abstract data types. Embodiments may be practiced in distributing computing environments where tasks are performed by remote processing devices that are linked through a communications network. In a distributed computer environment, program modules may be located in both local and remote computer storage media including media storage devices.

In one embodiment, simulator system application 200 includes a simulation model 201 of a processor based system, a detector 202, and a simulation controller 204. Simulation model 201 is configured to have dynamically controlled simulation precision levels. Detector 202 is configured to detect a first trigger. Simulation controller 204 is configured to control simulation model 201 to simulate first processor actions a first precision level. Simulation controller 204 is configured to control simulation model 201 to dynamically change to a second precision level that is different than the first precision level based on the first trigger. In one embodiment, the second precision level is significantly more precise than the first precision level. Simulation controller 204 is configured to control simulation model 201 to simulate second processor actions at the second precision level.

Simulator system application 200 is configured to dynamically vary simulation precision such that while simulation model 201 is simulating the second processor actions at the second precision level, detector 202 is configured to detect a second trigger. Simulation controller 204 is configured to control simulation model 201 to dynamically change the simulation back to the first precision level based on the second trigger. Thereafter, simulation controller 204 is configured to control simulation model 201 to simulate third processor actions at the first precision level.

In one embodiment of simulator system application 200, each dynamic change between simulation precision levels is based on only one trigger. In one embodiment, each dynamic change between simulation precision levels is based on multiple triggers. In one embodiment, some dynamic changes between simulation prevision levels are based on one trigger and other dynamic changes are based on multiple triggers.

One embodiment of simulator system application 200 dynamically controls simulation precision levels for a variety of types of precision. Embodiments of simulator system application 200 can include any suitable number of overlapping and intersecting simulation precision levels, any suitable number of corresponding triggers that influence dynamic change in simulation precision levels, and any suitable number of transition points between the simulation precision levels. Simulation precision levels herein refer to levels of emulation faithfulness (i.e., the levels of faithfulness that the simulation provides relative to the processor based system being simulated).

In one embodiment, some of the application programs on computing device 100, such as simulator system application 200, are configured to present a user interface (UI) that is configured to allow a user to interact with the application program in some manner using some type of input device. UI 206 is such a user interface which can be part of simulator system application 200 or some other application program running on computing device 100 or on other computers/applications 115. In one embodiment, UI 206 is a visual display that is capable of receiving user input and processing that user input in some way. Embodiments of UI 206 can, for example, include one or more user interactable components (e.g., links, buttons, or controls) that can be selected (e.g., clicked) by user via a pointing device. In one embodiment, a user may enter commands and information into computing device 100 via input devices 112. In one embodiment, one or more triggers that influence dynamic change in simulation precision levels are provided to detector 202 via user control input received via UI 206.

There are many other example triggers that can influence dynamic change in simulation precision levels in embodiments of simulator system application 200, such as discussed below and illustrated in the Table of FIG. 5. For example, a programmer command invoked by software in simulation model 201 can be detected by detector 202 to trigger a change in simulation precision levels. Another example trigger that influences dynamic change in simulation precision levels is simulator system application 200 interaction with debugger breakpoints and/or debugger single-stepping provided from a debugger 208. In one embodiment debugger 208 is an application program on computing device 100. In other embodiments debugger 208 is an application on other computers/applications 115.

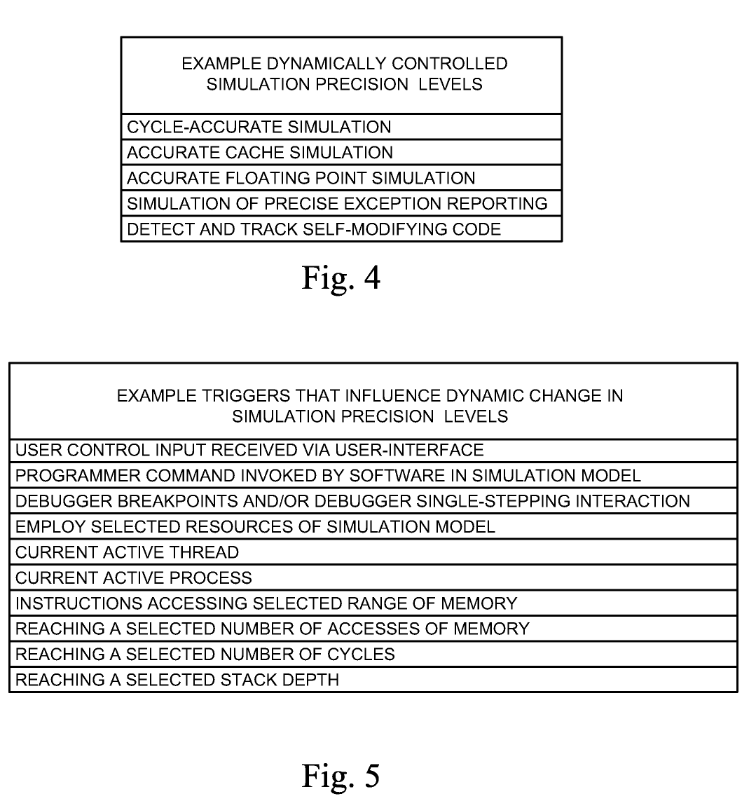

Example types of dynamically controlled simulation precision levels in embodiments of simulator system application 200 are discussed in more detail below and are, for example, illustrated in the Table of FIG. 4. For example, in one embodiment simulator system application 200 dynamically controls when cycle-accurate simulation occurs. In one embodiment, for example, simulator system application 200 controls when accurate cache simulation occurs.

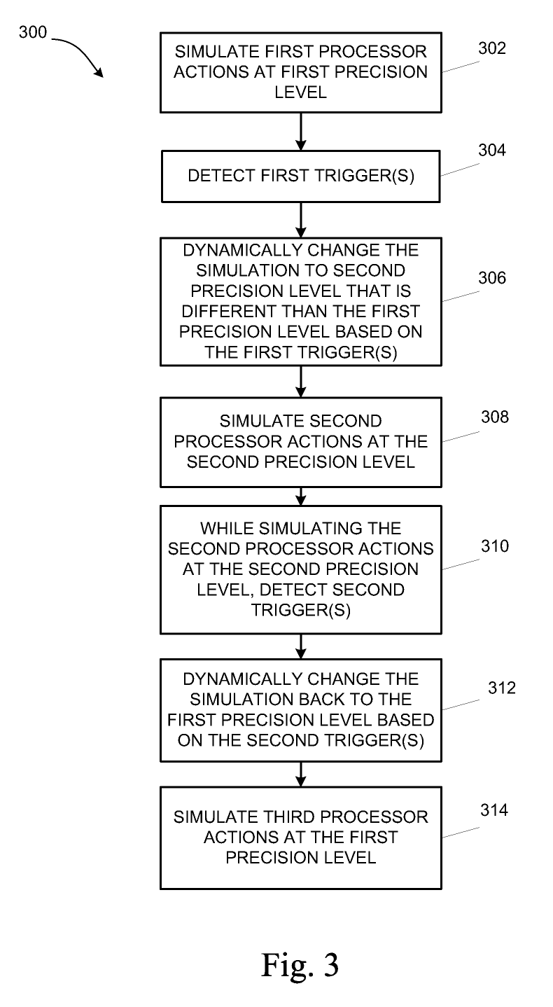

One embodiment of a method 300 performed by a simulator system application (e.g., simulator system application 200) is illustrated in flow diagram form in FIG. 3. Method 200 simulates a processor based system by dynamically varying or controlling simulation precision. At 302, the simulator system simulates first processor actions at a first precision level. At 304, the detector detects one or more first triggers. At 306, the simulator system dynamically changes the simulation to a second precision level that is different than the first precision level based on the one or more first triggers. In one embodiment, the second precision level is significantly more precise than the first precision level.

At 308, the simulator system simulates second processor actions at the second precision level. At 310, while the simulator system simulates the second processor actions at the second precision level, the detector detects one or more second triggers. At 312, the simulator system dynamically changes the simulation back to the first precision level based on the one or more second triggers. At 314, the simulator system simulates third processor actions at the first precision level.

Method 300 can be employed to dynamically control a variety of types of simulation precision levels. In addition, certain embodiments of method 300 can dynamically control different types of simulation precision levels in parallel.

Examples of types of dynamically controlled simulation precision levels which can be controlled by simulator system application 200 and method 300 are illustrated in the Table of FIG. 4. As illustrated by the examples provided in the Table of FIG. 4, simulator system application 200 and method 300 can vary the simulation precision level based on a variety of factors. In addition, method 300 can be employed to dynamically control simulation precision levels of many other various suitable types which are not provided in the Table of FIG. 4. These variety of factors enable a developer to dynamically vary and control simulation precision and simulation performance as deemed appropriate for the particular task at hand.

Referring to FIG. 4, one embodiment dynamically controls when cycle-accurate simulation occurs. In one form of this embodiment, the first precision level is not cycle-accurate, but the simulation runs significantly faster when method 300 simulates the first processor actions at the first precision level at 302 and simulates the third processor actions at the first precision level at 314. In this embodiment, the second precision level is cycle-accurate, but the simulation is significantly slower when method 300 simulates the second processor actions at the second precision level at 308. For example, in one embodiment the first precision level which is not cycle accurate is ten times faster than the second precision level which is cycle-accurate. Accordingly, simulator system application 200 and method 300 can dynamically vary the precision level (e.g., cycle-accurateness) of the simulation in order to enable on-the-fly tradeoffs between preciseness of the simulation and simulation performance or speed.

Referring to FIG. 4, another example type of dynamically controlled simulation precision levels is controlling when accurate cache simulation is performed. For example, in one embodiment the processor based system being simulated includes a cache, but the first precision level does not simulate the cache. However, the simulation runs significantly faster when method 300 simulates the first processor actions at the first precision level at 302 and simulates the third processor actions at the first precision level at 314. In this embodiment, the cache of the processor based system is accurately simulated at the second precision level, but method 300 simulates the second processor actions at the second precision level at 308 significantly slower than at the first precision level.

Another example type of dynamically controlled simulation precision levels includes controlling when accurate floating point simulation occurs. In this embodiment, the processor based system being simulated is configured to perform floating point operations and a first precision level does not simulate the floating point operations, but runs significantly faster when method 300 simulates first processor actions at the first precision level at 302 and simulates third processor actions at the first precision level at 314. In this embodiment, the second precision level accurately simulates the floating point operations, but method 300 simulates the second processor actions at the second precision level at 308 significantly slower than at the first precision level.

Another example type of dynamically controlled simulation precision levels is controlling when to simulate the precise reporting of exceptions. In this embodiment, the processor based system that is being simulated is configured to precisely report exceptions, but the first precision level does not simulate reporting of exceptions. However, method 300 simulates the first processor actions at the first precision level at 302 and simulates the third processor actions the first precision level at 314 significantly faster. In this embodiment, the second precision level simulates precise reporting of exceptions, but method 300 simulates the second processor actions at the second precision level at 308 significantly slower than at the first precision level.

Another example type of dynamically controlled simulation precision level illustrated in the Table of FIG. 4 is controlling when to detect and track self-modifying code. In this embodiment, the first precision level does not detect and track self-modifying code of a simulation model of a processor based system, but method 300 simulates the first processor actions at the first precision level at 302 and the third processor actions at the first precision level at 314 significantly faster. In this embodiment, the second precision level simulates precise reporting of exceptions, but method 300 simulates the second processor actions at the second precision level at 308 significantly slower than at the first precision level.

Example types of triggers that influence dynamic change in simulation precision levels in simulator system application 200 and method 300 are illustrated in FIG. 5. There are many other example types of triggers that could suitably be used to influence dynamic change in simulation precision levels in simulator system application 200 and method 300. Alone or combined, these example suitable triggers permit simulator system application 200 and method 300 to control simulation precision to fine-tune the performance of the simulation based on when these triggers occur. These example suitable triggers and the above described example suitable dynamically controlled simulation precision levels, such as illustrated in the Table of FIG. 4, enable improved simulation efficiency in employment of a simulator. For example, a user of the simulator does not need to wait for the simulator to simulate a selected functionality that is not currently relevant at a significant cost in simulation development time and money. By not simulating the selected functionality that is not currently relevant at the first precision level, simulator system application 200 and method 300 more quickly proceed to the part of the simulation where the selected functionality is currently relevant and the selected functionality can then be simulated at the second precision level.

The example triggers that influenced dynamic change in simulation precision levels illustrated in the Table of FIG. 5 and other suitable triggers are generally unobtrusive to the general operation of simulator system application 200. Accordingly, suitable triggers do not generally significantly slow down the simulation performed by simulator system application 200 by checking a very large amount of state or data frequently through the simulation.

Referring to FIG. 5, one example type of trigger that influences dynamic change in simulation precision levels is a trigger including at least one user control input received via a user interface, such as UI 206. Another example trigger that influences dynamic change in simulation precision levels is a programmer command invoked by software in the simulation model of the processor based system (e.g., simulation model 201).

Another example type of trigger that influences dynamic change in simulation precision levels is based on interaction with at least one of debugger breakpoints and debugger single-stepping, such as via debugger 208. To some extent, many suitable triggers are similar to what is desirable in a debugger, such that for example, breakpoints in the debugger can be employed so that the user can employ breakpoints in the debugger to not only be triggers to stop the debugger but also be triggers to control the behavior of the simulator system.

Another type of trigger that influences dynamic change in simulation precision levels is to employ selected resources of the simulation model of the processor based system. For example, in one embodiment the selected resources are selected cache modes of operation of the simulation model of the processor based system being simulated. In one form of this embodiment, detection of the execution of a first instruction in the simulation model that indicates that selected cache modes of operation are being entered is a trigger to dynamically enable accurate simulation of cache operations.

Generally, processor based systems execute processes that include a sequence of instructions that is executable by hardware threads. The hardware threads typically represent execution cores of one or more processors of the processor based system. For example, in computing device 100, one or more processing units 102 include hardware threads which are each configured to access and execute process instructions stored in system memory 104 as a process. As illustrated in FIG. 5, one embodiment of simulator system application 200 and method 300 simulates processor actions that include multiple threads and a trigger that influences dynamic change in simulation precision levels is based on a current active thread being simulated. One embodiment of simulator system application 200 and method 300 simulates multiple processes and a trigger that influences dynamic changes in simulation precision levels is based on a current active process being simulated.

One embodiment of simulator system application 200 and method 300 simulate processor actions that include instructions that access a memory of the processor based system being simulated. As illustrated in FIG. 5, in one embodiment, a trigger that influences dynamic change in simulation precision levels is based on the simulated instructions accessing a selected range of memory. In one embodiment, simulator system application 200 and method 300 simulate accesses of memory of the processor based system being simulated and an example trigger that influences dynamic changes in simulation precision levels is based on reaching a selected number of accesses of the memory of the processor based system being simulated.

In one embodiment of simulator system application 200 and method 300, an example trigger that influences dynamic change in simulation precision levels is based on the simulation reaching a selected number of cycles performed by processor actions being simulated at a first precision level.

Processor based systems typically are configured to perform call operations that include call functions that increase stack depth. One embodiment of simulator system application 200 and method 300 include a trigger that influences dynamic change in simulation precision levels that is based on reaching a selected stack depth in the simulation model of the processor based system. Stack depth is a reasonable criteria to trigger on, because reaching a new highwater mark can often be indicative of new unexplored portions of the simulated system being enter for the first time.

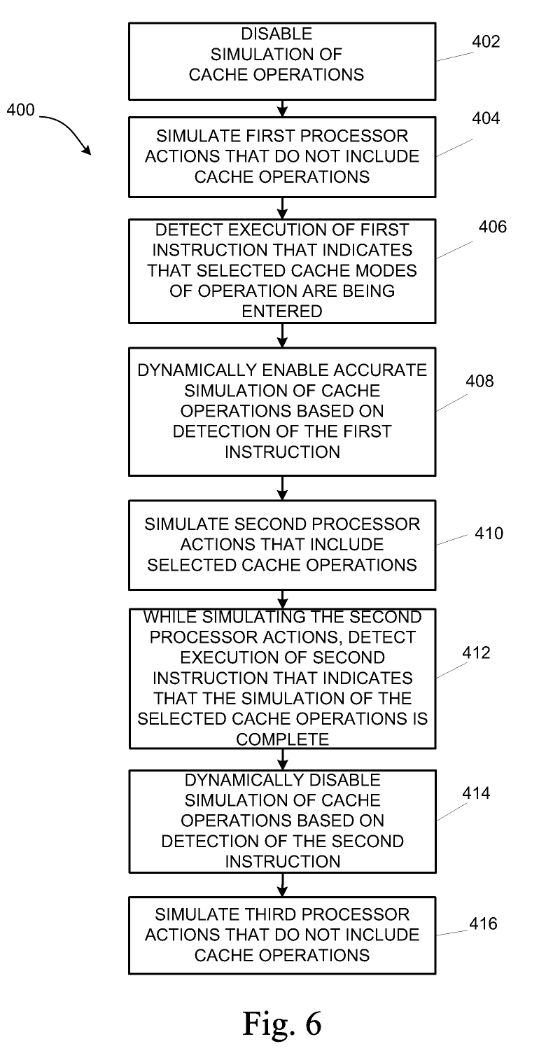

As illustrated in FIGS. 4 and 5, there are a large variety of suitable combinations of possible types of example dynamically controlled simulation precision levels and corresponding example triggers that influence dynamic change in simulation precision levels that can be employed by simulator system application 200 and method 300. FIGS. 6-8 each illustrate a specific example embodiment of a method that dynamically varies simulation precision based on a selected example type of dynamically controlled simulation precision levels and a corresponding example trigger that influences dynamic change in the controlled simulation precision levels.

One embodiment of a method 400 performed by a simulator system application (e.g., simulator system application 200) is illustrated in flow diagram form in FIG. 6. At 402, the simulation of cache operations is disabled. At 404, the simulator system simulates first processor actions that do not include cache operations. At 406, the detector detects execution of a first instruction that indicates that selected cache modes of operation are being entered in the simulation. At 408, the simulator system dynamically enables accurate simulation of cache operations based on detection of the first instruction.

At 410, the simulator system simulates second processor actions that include selected cache operations. At 412, while the simulator system is simulating the second processor actions, the detector detects execution of a second instruction that indicates that the simulation of the selected cache operations is complete.

At 414, the simulator system dynamically disables simulation of cache operations based on the detector detecting the second instruction. At 416, the simulator system simulates third processor actions that do not include cache operations.

In one example embodiment of method 400, the simulation of the first processor actions that do not include cache operations at 404 and the simulation of the third processor actions that do not include cache operations at 416 are performed approximately 50 times faster than the simulation of the second processor actions that include selected cache operations at 410. Method 400 can more quickly simulate the first processor actions that do not include cache operations at 404 and the third processor actions that do not include cache operations at 416 where a hardware or software developer does not deem that the first processor actions and the second processor actions have relevant simulation concerning cache operations. As a result, method 400 can more quickly get to the simulation of the second processor actions that includes selected cache operations or other processor actions that include selected cache operations where the developer deems the functionality of the cache is relevant to the development process. The simulation of the second processor actions or other processor actions that include selected cache operations is significantly slower, but is employed to get the relevant simulation of the cache operations. Overall the total simulation time of method 400 is significantly reduced by not simulating cache operations during the first processor actions and third processor actions and for other simulations of processor actions when the simulation of cache operations is disabled.

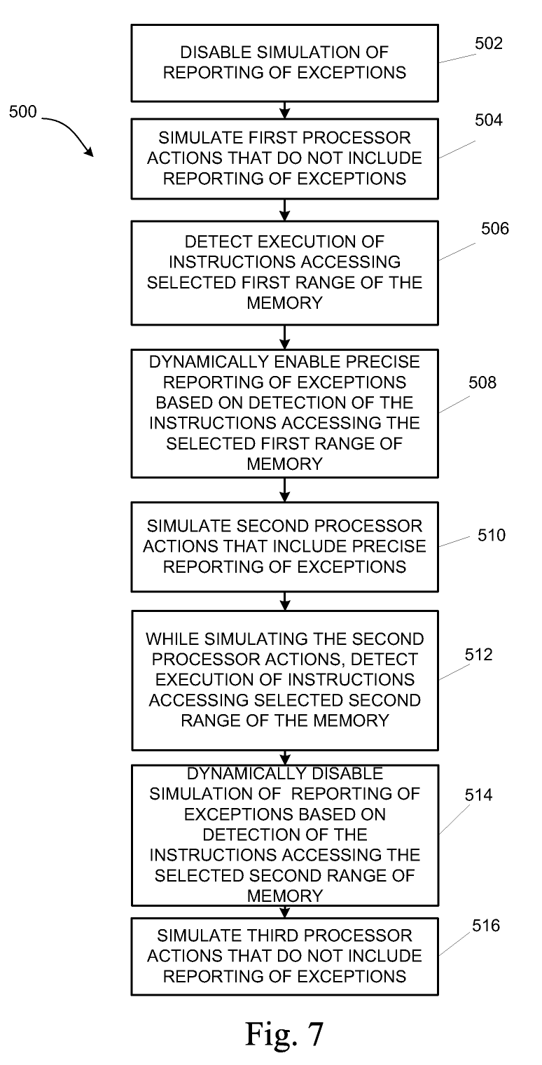

One embodiment of a method 500 performed by a simulator system application (e.g., simulator system application 200) is illustrated in flow diagram form in FIG. 7. At 502, the simulator system disables simulation of reporting of exceptions. At 504, the simulator system simulates first processor actions that do not include reporting of exceptions. At 506, the detector detects simulating execution of instructions accessing a selected first range of the memory of the processor based system. At 508, the simulator system dynamically enables precise reporting of exceptions based on detection of the instructions accessing the selected first range of memory being simulated.

At 510, the simulator system simulates second processor actions that include precise reporting of exceptions. At 512, while the simulator system is simulating the second processor actions, the detector detects simulating execution of instructions accessing a selected second range of the memory.

At 514, the simulator system dynamically disables simulation of reporting of exceptions based on the detection of the instructions accessing the selected second range of memory being simulated. At 516, the simulator system simulates third processor actions that do not include reporting of exceptions.

One embodiment of method 500 simulates the first processor actions that do not include reporting exceptions at 504 and the third processor actions that do not include reporting of exceptions at 516 significantly faster than the simulation of the second processor actions that include precise reporting of exceptions at 510.

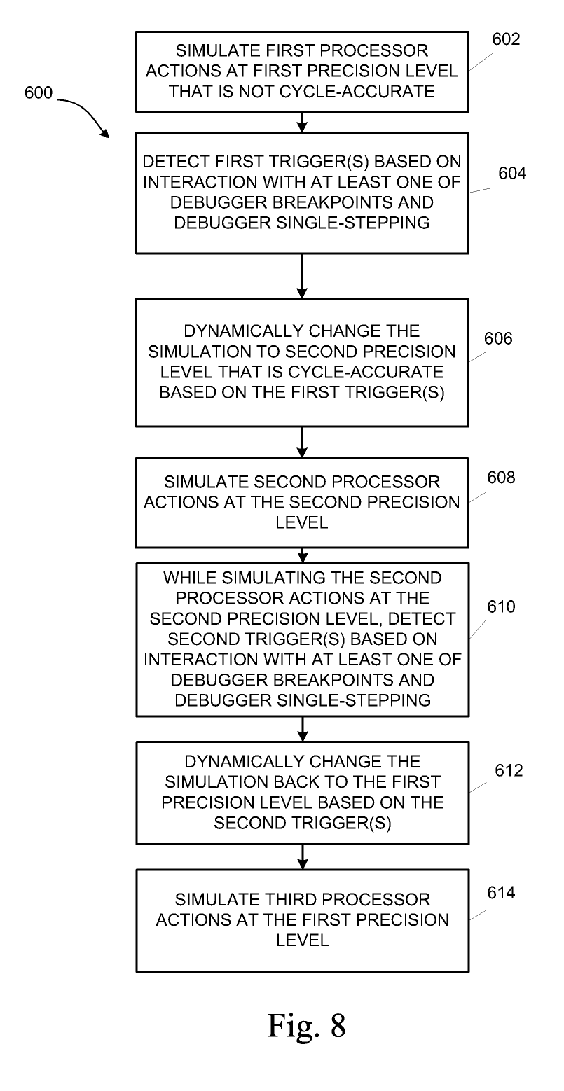

One embodiment of a method 600 performed by a simulator system application (e.g., simulator system application 200) is illustrated in flow diagram form in FIG. 8. At 602, the simulator system simulates first processor actions at a first precision level that is not cycle-accurate. At 604, the detector detects one or more first triggers based on interaction with at least one of debugger breakpoints and debugger single-stepping. The least one of debugger breakpoints and debugger single-stepping can, for example, be provided by a debugger, such as debugger 208.

At 606, the simulator system dynamically changes the simulation to a second precision level that is cycle-accurate based on the one or more first triggers. At 608, the simulator system simulates second processor actions at the second precision level. At 610, while the simulator system is simulating the second processor actions at the second precision level, the detector detects one or more second triggers based on interaction with at least one of debugger breakpoints and debugger single-stepping via a debugger.

At 612, the simulator system dynamically changes the simulation back to the first precision level based on the one or more second triggers. At 614, the simulator simulates third processor actions at the first precision level.

One embodiment of method 600 simulates the first processor actions at the first precision level that is not cycle-accurate at 602 and the third processor actions at the first precision level that is not cycle-accurate at 614 significantly faster than simulating the second processor actions at the second precision level that is cycle-accurate at 608. One example embodiment of method 600 simulates the first processor actions and the third processor actions at the first precision level that is not cycle-accurate approximately ten times faster than simulating the second processor actions at the second precision level that is cycle-accurate.

In embodiments, any suitable dynamically controlled simulation precision level can be triggered to be varied by any suitable trigger the influences a dynamic change in simulation precision levels. In one embodiment, one trigger can trigger more than one precision level change. In one embodiment, one precision level change can be triggered by more than one trigger. According to embodiments any suitable alone or combined dynamically controlled simulation precision levels can be implemented with corresponding one or more triggers, and these combinations can be run sequentially or in parallel. These examples of dynamically controlled simulation precision levels and example triggers that influence dynamic change in simulation precision levels provide the possibility for the hardware or software developer to dynamically fine-tune the tradeoffs between the precision of the simulation and the simulation performance. In this way, the dynamically varying of simulation precision according to embodiments can be employed to optimize simulation performance and precision to provide proper validation of relevant selected functionality but still provide significantly reduced costs in time and money.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of simulating a processor based system, the method comprising:
simulating first processor actions at a first precision level;
detecting a first trigger;
dynamically changing the simulation to a second precision level that is different than the first precision level based on the first trigger; and
simulating second processor actions at the second precision level.

2. The method of claim 1 comprising:
detecting multiple first triggers; and
wherein the dynamically changing the simulation to the second precision level is based on the multiple first triggers.

3. The method of claim 1 comprising:
while simulating the second processor actions at the second precision level, detecting a second trigger;
dynamically changing the simulation back to the first precision level based on the second trigger; and
simulating third processor actions at the first precision level.

4. The method of claim 1, wherein the first precision level is not cycle-accurate and the second precision level is cycle-accurate.

5. The method of claim 1 wherein the processor based system includes a cache and the first precision level does not simulate the cache and the second precision level accurately simulates the cache.

6. The method of claim 1 wherein the processor based system is configured to perform floating point operations and the first precision level does not simulate the floating point operations and the second precision level accurately simulates the floating point operations.

7. The method of claim 1 wherein the processor based system is configured to precisely report exceptions and the first precision level does not simulate reporting of exceptions and the second precision level simulates precise reporting of exceptions.

8. The method of claim 1 wherein the first precision level does not detect and track self-modifying code of the processor based system and the second precision level detects and tracks self-modifying code of a simulation model of the processor based system.

9. The method of claim 1 wherein the first trigger comprises at least one user control input received via a user-interface.

10. The method of claim 1 wherein the first trigger comprises at least one programmer command invoked by software in a simulation model of the processor based system.

11. The method of claim 1 wherein the first trigger is based on interaction with at least one of debugger breakpoints and debugger single-stepping.

12. The method of claim 1 wherein the first trigger is based on employment of selected resources of a simulation model of the processor based system.

13. The method of claim 1 wherein first processor actions includes multiple threads and the first trigger is based on a current active thread being simulated.

14. The method of claim 1 wherein first processor actions includes multiple processes and the first trigger is based on a current active process being simulated.

15. The method of claim 1 wherein the first processor actions include instructions that access a memory of the processor based system and the first trigger is based on the instructions accessing a selected range of the memory being simulated.

16. The method of claim 1 wherein the first processor actions include accesses of a memory of the processor based system and the first trigger is based on reaching a selected number of accesses of the memory being simulated.

17. The method of claim 1 wherein the first trigger is based on the simulating reaching a selected number of cycles performed by the first processor actions.

18. The method of claim 1 wherein the processor based system is configured to perform call operations that include call functions that increase stack depth, wherein the first trigger is based on reaching a selected stack depth in a simulation model of the processor based system.

19. A simulator system comprising:
a simulation model of a processor based system;
a detector configured to detect a first trigger;
a simulation controller configured to control the simulation model to simulate first processor actions at a first precision level, dynamically change to a second precision level that is different than the first precision level based on the first trigger, and simulate second processor actions at the second precision level.

20. A computer readable storage medium storing computer-executable instructions for controlling a computer system to perform a method comprising:
simulating first processor actions at a first precision level;
detecting a first trigger;
dynamically changing the simulation to a second precision level that is different than the first precision level based on the first trigger;
simulating second processor actions at the second precision level;
while simulating the second processor actions at the second precision level, detecting a second trigger;
dynamically changing the simulation back to the first precision level based on the second trigger; and
simulating third processor actions at the first precision level.
